(19) United States
(12) Patent Application Publication
(10) Pub. No.: US 2011/0097249 A1
(43) Pub. Date: Apr. 28, 2011

(54) Centrifuge cartridge

(75) Inventors: Gernot Busch, Effingen (CH); Sandro M.O.L. Schneider, Thalwil (CH); Sebastian Stahl, Karlsruhe (DE); Werner Stahl, Landau (DE)

(73) Assignee: Ferrum AG, Rupperswil (CH)

(21) Appl. No.: 12/854,118

(22) Filed: Aug. 10, 2010

Related U.S. Application Data
(62) Division of application No. 11/600,594, filed on Nov. 15, 2006, now abandoned.

(30) Foreign Application Priority Data
Nov. 18, 2005 (EP) 05405649.4

(51) Int. Cl. B01D 45/00

(52) U.S. Cl. 422/533

(57) ABSTRACT

The invention relates to a centrifuge cartridge (1) for a centrifuge (2) for the separation of a mixture (3) into a solid cake (4) and into a liquid phase 5), with the centrifuge cartridge (1) being rotatably supported around an axis of rotation (6) of the centrifuge (2) in the installed state. The centrifuge cartridge (1) is releasably installed in the centrifuge (2), in particular in a centrifuge drum (21) of the centrifuge (2).

This application claims the priority of European Patent Application No. 05405649.4, dated Nov. 18, 2005, the disclosure of which is incorporated herein by reference.

The invention relates to a centrifuge cartridge and to a centrifuge having a centrifuge cartridge in accordance with the preamble of claims 1 and 13.

Centrifuges in the most varied embodiments are widespread and are used in the most varied fields for the dehumidification of moist substances or moist substance mixtures. Discontinuously operating centrifuges such as scraper centrifuges are thus, for example, preferably used for the dehumidification of very pure pharmaceutical products, whereas continuously operating pusher centrifuges are advantageously used in particular when large amounts of a solid-liquid mixture are to be separated continuously. In addition, the so-called decanting centrifuges which are on the market in the most varied embodiments and which are used for the most varied purposes have a very large commercial importance. The monograph “Industriezentrifugen” [Industrial Centrifuges], DrM Press, 2004, by Prof. Werner H. Stahl, for example, provides an excellent overview of the prior art in the field of industrial centrifuges.

All centrifuges share the common feature that a solid-liquid mixture, for example a suspension or a moist salt or salt mixture, is supplied, for example, through an inlet pipe via a mixture distributor to a fast-rotating drum which can, for example, be designed as a filter screen so that the liquid phase is separated off through the filter screen due to the active centrifugal forces, whereas a solid cake is deposited at the interior on the drum wall.

Another important basic principle is realised in the already mentioned decanting centrifuge, also frequently simply called a “decanter”. The rotor of a decanting centrifuge consists of a full jacket drum with a cylindrical part and a conical part and a worm element supported therein. Both rotate at a high speed of revolution, with the worm having a comparatively low rotational difference with respect to the drum. This rotational difference serves for the transport of the settled solid from the full-jacket drum. The solid settles on the inner wall of the drum due to the difference of density between the denser solid and the less dense liquid. The clarifying suspension liquid flows over this in the passages formed by the worm blades in a spiral manner in the direction of an overflow weir, also called a decanter weir, at the end of the drum and decants there into the surrounding liquid housing.

Tubular centrifuges, a type of centrifuge to be subsumed under the term “separators”, are as a rule suspended vertically and substantially consist of a drum with a small diameter. In order to obtain a relatively large solid volume and a large equivalent clarification area despite the small diameter, the axial extent of the tubular drum as a rule amounts to a multiple of its diameter, i.e. these drums have large slenderness ratios. The centrifuge liquid, that is the mixture to be separated, normally enters the drum in a free jet from below. A baffle plate breaks the liquid jet and radially standing plates bring the jet product to the angular speed of the drum. The separated liquid flows in a surface flow to the upper end of the drum where it leaves it via an overflow weir. Once a maximum amount of solid cake has been deposited in the drum, the tubular centrifuge is stopped and the solid cake is removed.

Depending on the type used, it is no problem with modern heavy duty centrifuges to achieve up to 2,000 revolutions per minute, up to 10,000 revolutions per minute or even up to 20,000 revolutions per minute and more in dependence on the drum diameter, the substance to be centrifuged, etc. As a rule, in this process, a larger drum diameter causes a smaller maximum rotational frequency of the drum due to the strong centrifugal forces which occur. The operating parameters such as the rotational frequency of the drum, the amount of mixture supplied per unit of time or also the drum diameter and/or the type of centrifuge used can naturally also depend on the substance to be dehumidified itself, the content of liquid, etc. It is clear that the procedure of the solid discharge as such can generally not be satisfactory with this type of centrifuges for the most varied of reasons.

Apart from the fact that every type of centrifuge has very specific advantages and disadvantages and that every type of centrifuge is optimised for very specific tasks and is less suitable for other tasks, there is frequently a general problem with all types of centrifuge, in particular with the processing of particularly sensitive substances such as in the processing of very pure pharmaceutical, cosmetic or chemical products, that the centrifuge has to be repeatedly cleaned in a complex and expensive manner after the ending of a dehumidification process by the centrifuge in order to observe the required hygienic standards, which is very complex, i.e. in particular also time-consuming, and thus expensive.

This is in particular a problem when different substances, in particular very pure and highly sensitive substances, have to be centrifuged and dehumidified sequentially, without contamination or even mixing of the sequentially centrifuged substances being allowed to occur.

A further problem can result in the processing of more or less pronouncedly abrasive suspensions, or for example physically and/or chemically aggressive suspensions. The centrifuge drums are as a rule produced from very high-quality materials which can be attacked and damaged by aggressive suspensions of this type. This commonly results in complex and expensive repair work on the high-quality centrifuge drums which even have to be completely replaced in the worst case.

Another problem which has essentially not yet been solved is the so-called “drag” which is known in particular, but not only, from separators such as tubular centrifuges and decanters. This is understood such that the flow speed of the mixture to be separated over the already settled solid cake becomes larger and larger in the operating state with increasing sedimentation thickness of the solid cake at the inner drum wall of the centrifuge with unchanging supply speed of the mixture to be separated. This has the consequence that the liquid flowing off, which is drained from the drum of the centrifuge in a manner known per se in a decanting centrifuge, for example, via a decanter weir at the end of the drum, takes along increasingly more material to be settled and thus drains it from the drum before it can settle as a solid cake. This previously described effect of “drag” has the result that the centrifuge has to be switched off prematurely in practice with a degree of filling of the centrifuge drum of only approximately 60% because the efficiency in the sedimentation of the mixture has reduced to an intolerable level. This state can also already be reached in certain cases with a degree of filling of less than 60%, with 60% being a characteristic value for biotechnological products, for example.

It is therefore the object of the invention to provide an apparatus with which these disadvantages known from the prior art are largely overcome.

The subject matters of the invention satisfying these objects are characterised by the features of the independent claims 1 and 13.

The independent claims relate to particularly advantageous embodiments of the invention.

The invention thus relates to a centrifuge cartridge for a centrifuge for the separation of a mixture into a solid cake and into a liquid phase, with the centrifuge cartridge being rotatably supported around an axis of rotation of the centrifuge in the installed state. The centrifuge cartridge can be releasably installed in the centrifuge, in particular in a centrifuge drum of the centrifuge.

It is an essential feature of the invention that, for the first time, a centrifuge cartridge is provided which can be releasably connected to the centrifuge, i.e. which can, for example, be releasably installed in a centrifuge drum of a centrifuge known per se. This means that the centrifuge cartridge is an independent element which is not solidly connected to the rotor or to the drum of the centrifuge, but releasably. Since the centrifuge cartridge in accordance with the invention can be releasably connected to the rotor and/or to the centrifuge drum of a centrifuge, the centrifuge cartridge is generally suitable for installation into practically all known types of centrifuge; no matter whether vertically or horizontally supported centrifuges, continuously or discontinuously operating centrifuges, such as separators, specifically tubular centrifuges, but also in scraper centrifuges, decanting centrifuges, slide centrifuges or oscillating centrifuges, the centrifuge cartridge in accordance with the present invention can be advantageously installed. Even in a pusher centrifuge, e.g. after deactivation or dismantling of the pusher base or other pushing apparatuses, the centrifuge cartridge in accordance with the invention can be used beneficially in specific cases and for very specific applications.

It is understood that different modifications or conversions have to be carried out as a rule before the installation of the centrifuge cartridge depending on the type of centrifuge. For example, with a scraper centrifuge, the scraper mechanism thus has to be removed, deactivated or at least matched to the centrifuge cartridge such that the scraper centrifuge can be operated reliably with a centrifuge cartridge in accordance with the invention. The same applies more or less in an analogous manner to most of the previously named types of centrifuge, with the required modification or conversion work on the corresponding centrifuge or on its rotor or drum naturally being different.

The centrifuge cartridge of the present invention can be installed particularly advantageously in tubular centrifuges, since here the necessary conversion work or modification are the least complex and expensive in comparison with other centrifuges such as with a scraper centrifuge.

However, the centrifuge cartridge can also be used particularly advantageously not only with a tubular centrifuge for another reason.

A further extremely important advantage of the centrifuge cartridge in accordance with the invention will be shown for this purpose in the following by way of example of a tubular centrifuge as representative for all types of centrifuges. A previously only unsatisfactorily solved problem, particularly with the tubular centrifuge, but not only with this, is the solid extraction. The so-called “Carr centrifuge” admittedly permits automatic solid extraction within certain limits, but it is also the case here that the centrifuge always has to be cleaned again in a time-consuming and costly manner after the end of a dehumidification process of the products in the centrifuge when particularly sensitive substances are to be processed such as very pure pharmaceutical, cosmetic or chemical products, which are subject inter alia to the highest hygienic demands, in order to observe the mentioned hygienic standards, which is very complex, i.e. also time-consuming and so extremely expensive. In addition, an association of the storage container from which a section of the centrifuge was fed is not unambiguously possible (key word “batch identification”).

All of these problems are eliminated by the use of the centrifuge cartridge in accordance with the invention since, for example after a completed workstep, that is when the mixture disposed in the centrifuge cartridge has reached a predetermined degree of dehumidification, the whole cartridge can simply be removed together with the thickened solid cake and the production process can be continued immediately by use of another centrifuge cartridge, without the centrifuge as such having to be cleaned in a complex manner or having to be prepared in some way for the following production step for the dehumidification of the next mixture load.

Even completely different substances, also very pure and highly sensitive substances, can thus be centrifuged and dehumidified sequentially in one and the same centrifuge, without a contamination of the sequentially centrifuged substances having to be feared, and indeed without the centrifuge or the drum or the rotor having to be cleaned in the meantime.

Due to the use of the centrifuge cartridge in accordance with the invention, the problems which result in the processing of more or less highly abrasive suspensions or, for example, physically and/or chemically aggressive suspensions, are also solved elegantly and in a simple and highly efficient manner. The centrifuge drums which, as already mentioned, are as a rule made of very high-quality materials, no longer come into direct contact with such aggressive suspensions and are therefore also no longer attacked and damaged by them. This means that a centrifuge cartridge in accordance with the invention can thus also be used particularly advantageously as a “wear protection cartridge”. Time-consuming and expensive repair work on the high-quality centrifuge drums is thus superfluous. The centrifuge cartridge in accordance with the invention can itself, for example, be made of inferior materials so that an exchange of a damaged centrifuge cartridge is also efficient and justifiable under economic aspects.

In this context, it should again expressly be emphasised that the use of a centrifuge cartridge in accordance with the invention is not restricted to a specific type of centrifuge, which not least hugely increases the flexibility and economic aspect of an existing centrifuge machine park.

The releasable installation of a centrifuge cartridge in accordance with the invention in the centrifuge can be provided in any suitable manner which permits a simple installation and removal of the centrifuge cartridge. It is thus possible, for example, that support bolts are provided in the centrifuge, in particular at the centrifuge drum, which are designed and arranged such that a centrifuge cartridge in accordance with the invention can be positioned in the drum with a precise fit and supported by the support bolts, without any further fastening means having to be provided for fastening. Alternatively or additionally, simply releasable securing means such as screws or nuts, e.g. wing screws or wing nuts or other easily releasable screws and/or nuts can also be provided to install the centrifuge cartridge in the centrifuge in a secure and releasable manner. It is also possible for the centrifuge cartridge to be able to be installed in the centrifuge or in the centrifuge drum with easily releasable fast fastenings such as snap-in fastenings, with a releasable coupling device, e.g. an eccentric lifter, a bayonet fastening or a screw connection, preferably, but not necessarily, in connection with the previously mentioned support bolts. It is understood that all or some of the aforesaid means or further suitable means not named here can be provided in a suitable manner both at the centrifuge itself and at the centrifuge cartridge.

The change of the cartridge can be carried out manually and/or semi-automatically and/or fully automatically. All the cartridges can be changed together or also individual cartridges can be changed separately.

Ultimately, the specific type of installation of a centrifuge cartridge in accordance with the invention in the centrifuge is of secondary importance. It only has to be ensured that the centrifuge cartridge can be connected to the centrifuge or to the centrifuge drum in a simple, releasable manner. How this is specifically done naturally also depends on the specific type of the centrifuge in which the centrifuge cartridge in accordance with the invention should be installed and must naturally have to be done such that a secure operation of the centrifuge with a centrifuge cartridge is ensured. In another respect, the skilled person knows how the centrifuge cartridge has to be installed in a specific centrifuge in a secure, reliable and releasable manner in the specific case.

In an embodiment important for practice, the centrifuge cartridge is a sub-cartridge. That is, at least two sub-cartridges are provided in a rotor or in a drum of a centrifuge known per se, for example in a tubular centrifuge, which can the same or different in their design and whose interior spaces can either be in communication with one another or can also be insulated from one another so that no material can move from one sub-cartridge into the other during a centrifugal process.

It is naturally also possible for a centrifuge cartridge in accordance with the invention and/or a sub-cartridge to itself again include one or more sub-cartridges so that a nestling arrangement of centrifuge cartridges and/or sub-cartridges is present.

The one or the other variant can be of advantage depending on demands. The initially already mentioned “dragging” is thus not only a known problem with tubular or decanting centrifuges. This is understood, as the skilled person is fully aware, such that the flow speed of the mixture to be separated over the already settled solid cake becomes larger and larger in the operating state with increasing sedimentation thickness of the solid cake at the inner drum wall of the centrifuge with unchanging supply speed of the mixture to be separated. This has the consequence that the liquid flowing off, which is drained from the drum of the centrifuge in a manner known per se in a tubular centrifuge, for example, via a decanter weir at the end of the drum, takes along increasingly more material to be settled and thus drains it from the drum before it can settle as a solid cake. In specific cases, even solid which has already settled and which has already been deposited on the surface of the sediment can be dragged off again by the high flow speed.

This previously described effect of drag has the result that the centrifuge has to be switched off prematurely in practice with a degree of filling of the centrifuge drum of only approximately 60% because the efficiency in the sedimentation of the mixture has reduced to an intolerable level. This state can also already be reached in certain cases with a degree of filling of less than 60%, with 60% being a characteristic value for biotechnological products, for example.

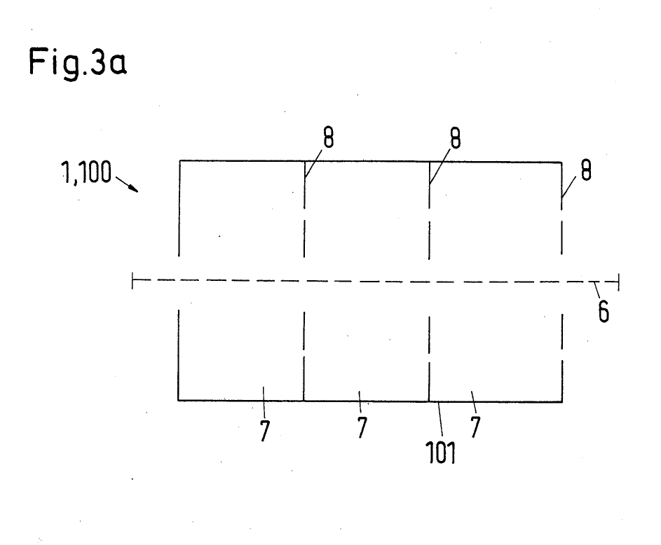

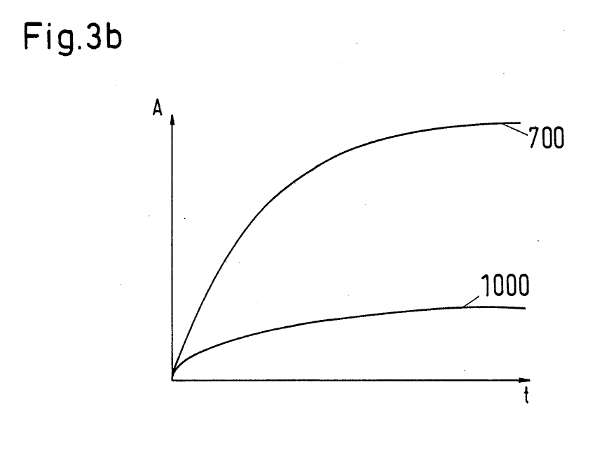

It has now surprisingly been found that this effect of dragging, also frequently called the “drag effect” in expert circles, can be hugely minimised when, for example, one or more decanting plates are arranged in the rotor or in the drum sequentially in the direction of the rotor axis at specific intervals, such as will be described in more detail further below for the example of FIG. 3a.

The use of sub-cartridges arranged sequentially in the rotor direction is suitable to deal with this problem in a special manner, with one or both end faces of each sub-cartridge, for example, being formed by a decanter weir such that the interior spaces of two sub-cartridges disposed next to one another are in communication via the openings of adjacent decanter weirs.

On the one hand, the previously described drag effect can thereby be almost completely suppressed and, on the other hand, solid cakes of e.g. different grain distribution can be settled in two different sub-cartridges, i.e. a separation can take place and/or solid cakes of different degrees of dehumidification or of different consistence can be isolated in two different sub-cartridges such that the sub-cartridges can be removed individually from the rotor of the centrifuge after the completion of a centrifuging process and thus solid cakes of different consistence are present automatically separated in the individual sub-cartridges as they are needed for further processing steps. In this process, the consistence of the solid cakes, in particular their different grain distribution and/or their different degrees of dehumidification, can be set directly by selection of different parameters such as the geometry of the sub-cartridges and/or the geometry of the end faces made as decanter weirs and/or the supply speed of the mixture to be separated and/or other parameters.

In another application, it can, in contrast, be of advantage or even necessary for the interior spaces of two different sub-cartridges to be insulated from one another, for example in that the end faces are designed as closed end surfaces so that no material can move from one sub-cartridge into another. This is, for example, of particular advantage when different substances which may not be mixed should be processed simultaneously in one and the same centrifuge and in one and the same centrifuging process.

The performance spectrum and the performance capability of existing centrifuge systems can thus be hugely expanded and improved by the use of the sub-cartridges in accordance with the present invention.

In a specific embodiment of a centrifuge cartridge in accordance with the invention, at least two sedimentation chambers are provided in the centrifuge cartridge which are arranged axially sequentially with respect to the axis of rotation. The at least two sedimentation chambers can, for example, be made in the form of decanter weirs analogously to the previously described examples so that the interior spaces of two different sedimentation chambers are in communication with one another. In another example, the sedimentation chambers can also be separated from one another by separation means, for example by separation plates, so that no material can move from one sedimentation chamber of a centrifuge cartridge into another sedimentation chamber of the same centrifuge cartridge.

It is understood that both two or more connected sedimentation chambers and one or more closed sedimentation chambers can be provided simultaneously in one and the same centrifuge cartridge. It is likewise clear that for specific applications a sedimentation chamber and/or a centrifuge cartridge and/or a sub-cartridge can be closed at one end face and can be open at the second end face, for example in that a decanter weir is provided at the second end face. It is additionally clear that a sub-cartridge can also have two or more sedimentation chambers.

The advantages and the function of closed and/or open sedimentation chambers have already been discussed in detail further above for the example of open, half-open or closed centrifuge cartridges as such or the combination of open and/or half open and/or closed sub-cartridges. The skilled person can easily transfer what has been said in this respect to a centrifuge cartridge and/or sub-cartridge having at least two sedimentation chambers.

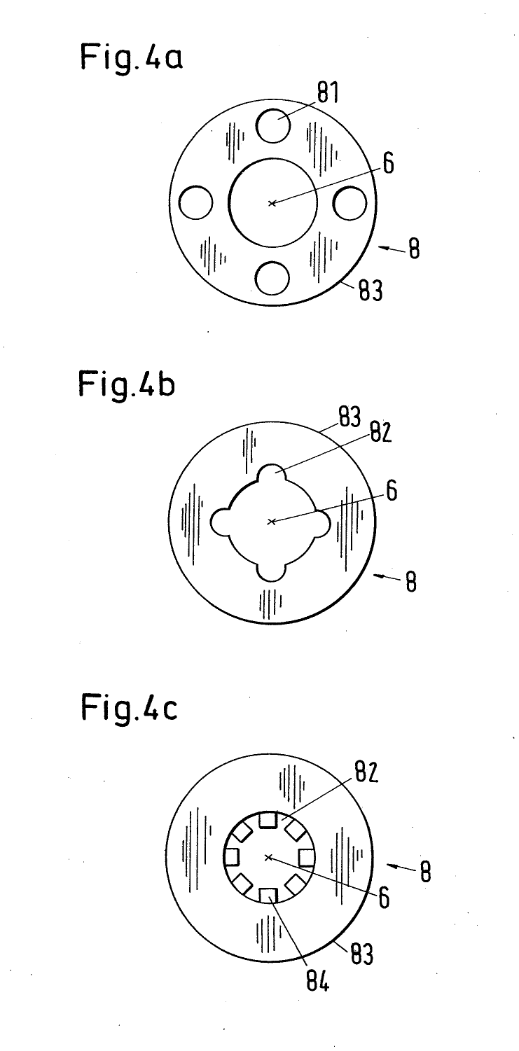

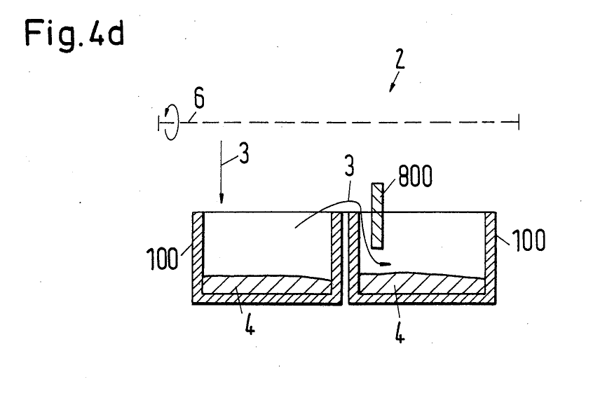

As already mentioned, the sedimentation chamber can be formed by a decanter weir, in particular by a decanter weir having an outflow opening and/or an outflow cut-out for the draining of the liquid phase. Decanter weirs per se and their specific embodiments are well known to the skilled person and therefore do not need to be described in more detail at this point. Reference is in particular made to the description of FIGS. 4a to 4c for the discussion of possible specific embodiment variants of decanter weirs.

In another specific embodiment of a centrifuge cartridge in accordance with the invention, the sedimentation chamber can itself be further divided into at least two portioning chambers, with the sedimentation chamber in particular being able to be made in the form of a honeycomb structure. The automatic portioning of the solid cake in predeterminable amounts is possible during centrifuging by the portioning chambers, which substantially facilitates the further processing and results in a substantial increase in efficiency.

It is in particular possible by a suitable process management and/or by a suitable combination of the above-described specific geometries, that is by a combination of open, half-open and closed centrifuge cartridges and/or sub-cartridges and/or by the suitable use of decanter weirs to portion the solid cake automatically in predeterminable amounts, with the portions formed being able to have different degrees of dehumidification and/or a predeterminable consistence and/or different grain distributions by the suitable use of the previously listed combinations.

It is understood that the sedimentation chambers and/or the portioning chambers can also be formed in a different manner, for example, but not exclusively, by one or more decanter worms, in particular by suitably nesting or non-nesting decanter worms.

It is clear that the sedimentation chambers and/or portioning chambers of a centrifuge cartridge can be of equal or different size so that, for example, portions of difference consistence and/or of different degrees of dehumidification can be manufactured and portioned simultaneously in one and the same centrifuge and in one and the same workstep. For example, a first sedimentation chamber can thus be larger than a second sedimentation chamber and/or a first portioning chamber can be larger than a second portioning chamber.

It is understood that the size of a sedimentation chamber or the interior space of a centrifuge cartridge and/or of a sub-cartridge is not only influenceable by variation of the axial extent, that is the length in the axial direction, but is naturally also determined by the diameter or radius, in particular by the internal diameter. It is therefore possible for a first radius of a first sedimentation chamber and/or of a first sub-cartridge to be larger than a second radius of a second sedimentation chamber and/or of a second sub-cartridge. Such arrangements are in particular suitable, as the skilled person knows, for the separation of a mixture, that is for the separation of the mixture into different solid cakes which differ, for example, by the size and/or the weight of the settled particles. This effect of the separation is in particular achieved in that different centrifugal accelerations apply due to the different diameters of the different sedimentation regions or the different sedimentation chambers with the same speed of revolution of the centrifuge, an effect which is well known per se and has also already been examined and discussed in detail in centrifuge engineering.

In an embodiment important for practice, the centrifuge cartridge and/or sub-cartridge includes, in a manner known per se, a filter screen at a radial peripheral surface for the draining of the liquid phase.

The centrifuge cartridge and/or sub-cartridge can be manufactured of metal and/or of plastic, in particular of injection-moulded plastic and/or of a composite material.

In particular when sensitive substances which may not e.g. be brought into contact with metal or when substances have to be processed on which very high purity demands are made or which have to satisfy the highest hygienic standards, an inner wall of the centrifuge cartridge and/or of the sub-cartridge and/or of the centrifuge drum itself can be lined, in particular lined with a plastic, specifically with a hygienic plastic.

In this process, a means for sealing can be provided at the cartridge opening of the centrifuge cartridge and/or of the sub-cartridge; and/or the centrifuge cartridge and/or the sub-cartridge can be made as a sealable container. The means for sealing can, for example, be a cover of a suitable material, a plastic foil or another suitable sealing means. A product-compatible liquid is also conceivable as the sealing means which is applied to the settled solid cake after the end of the sedimentation process and then hardens e.g. in the form of a sealing film. The liquid sealing means is, for example, applied to the settled solid cake, that is to the product, preferably still during the running of the centrifuge, so that the centrifuge cartridge or the sub-cartridge is already hermetically sealed when the centrifuge comes to a standstill.

The sealing could also be implemented via a central spigot or by similar devices, with the help of which the cartridge is then also removed, for example. These devices can then not only seal individual cartridges, but also a plurality of cartridges together, which can then in turn likewise be removed and/or installed individually or together. Designs with a snap-in or click system are possible as specific embodiments in addition to other solutions.

A sealed centrifuge cartridge and/or sub-cartridge is in particular of advantage when the solid cake formed in the centrifuge is subject to extreme purity criteria or when very strict hygiene is required.

If the centrifuge cartridge and/or the sub-cartridge is thus designed as a sealed container, the sealed cartridge can be removed from the centrifuge after the dehumidification has taken place, i.e. after compacting or centrifuging of the mixture has taken place, without the centrifuge cartridge having to be opened and without the solid cake being exposed to damaging environmental influences. The sealed centrifuge cartridge can then be supplied to a further production step or can be returned to a customer who has commissioned the mixture to be dehumidified in the centrifuge directly in the sealed container, without contamination of the solid cake being possible on the removal from the centrifuge or, for example, in transport.

The sealing of the centrifuge cartridge and/or of the sub-cartridge can take place directly after the filling with a mixture to be dehumidified in that, for example, the end faces serving as a filling opening are sealed, for example, with a cover or a foil and are only then put into the centrifuge for dehumidification, with suitable means which are known per se to the skilled person being provided to drain the left-over liquid. This procedure is in particular suitable when the centrifuge cartridge and/or the sub-cartridge has/have its/their own filter screen for the draining of the liquid phase.

It is understood that, in another case, the centrifuge cartridge and/or the sub-cartridge can also only be suitably sealed after the completion of a dehumidification process in the centrifuge.

The invention further relates to a centrifuge, in particular to a vertically supported or horizontally supported centrifuge, in particular a discontinuously operating centrifuge, specifically a separator, preferably a tubular centrifuge, a scraper centrifuge and/or a continuously operating centrifuge, in particular a decanting centrifuge, a slide centrifuge, a pusher centrifuge or an oscillating centrifuge having a centrifuge cartridge and/or a sub-cartridge as previously described in detail.

It is understood that the previously described embodiments of centrifuge cartridges in accordance with the invention are only to be understood by way of example and that in particular, but not only, all suitable combinations of the embodiments described in this application are covered by the invention.

The invention will be explained in more detail in the following with reference to the drawing. There are shown in a schematic representation:

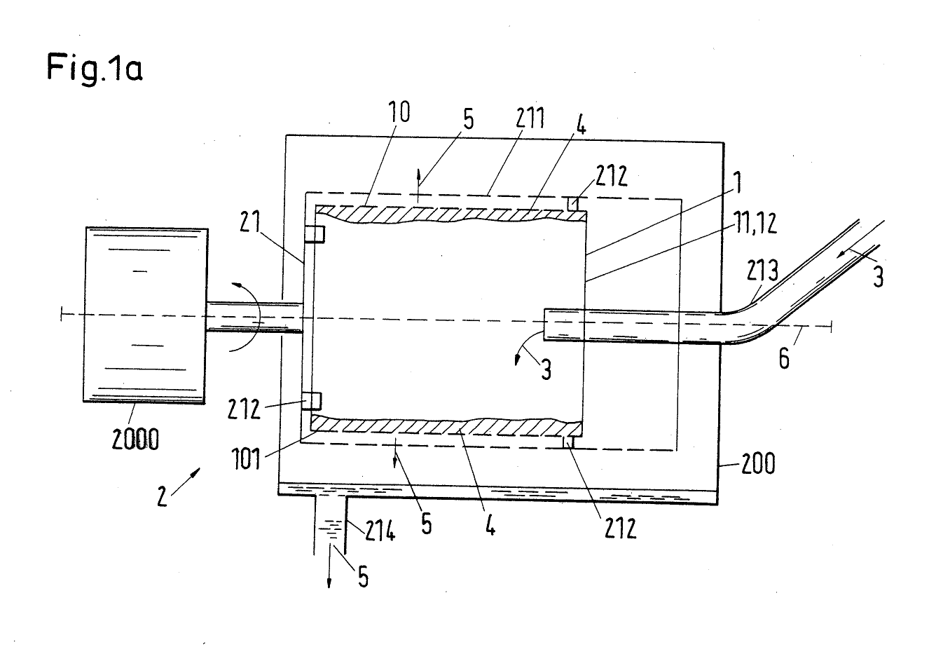

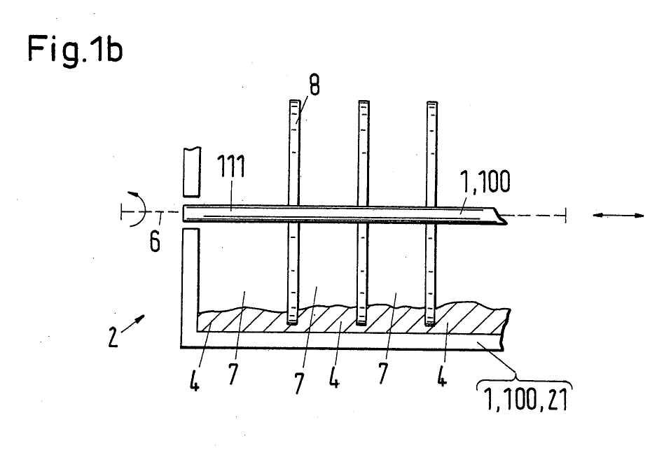

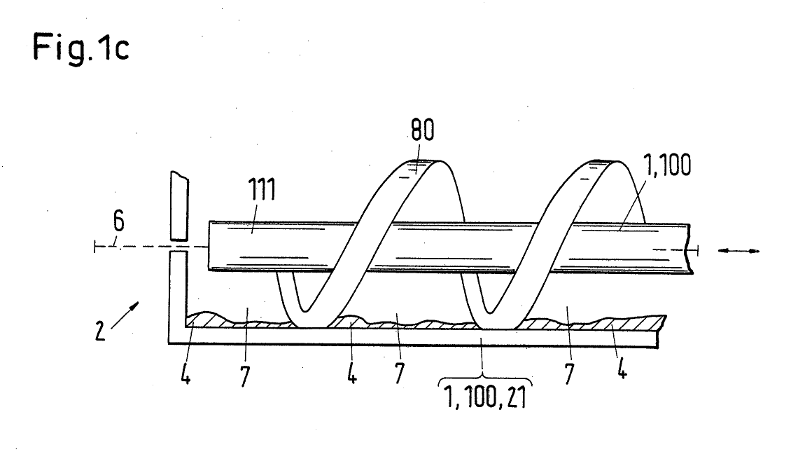

FIG. 1a a centrifuge with a centrifuge cartridge in accordance with the invention;

FIG. 1b a centrifuge cartridge without a drum jacket;

FIG. 1c a further embodiment in accordance with FIG. 1b;

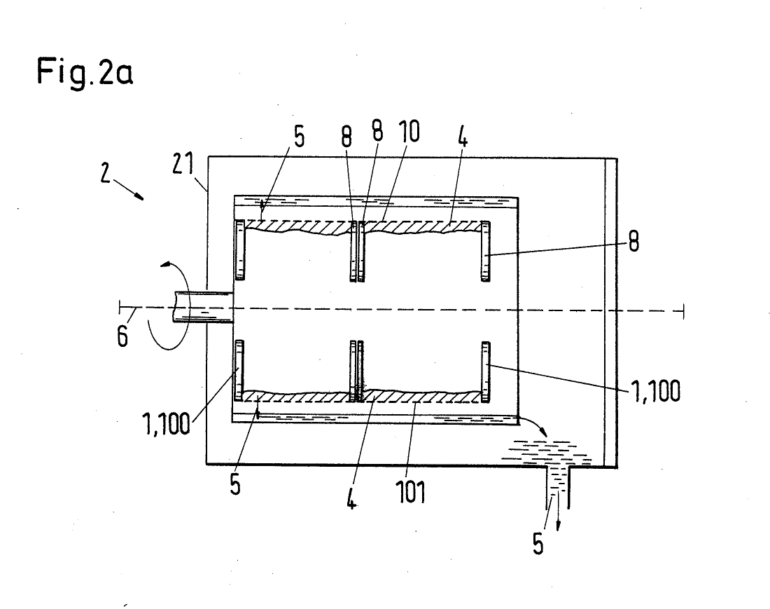

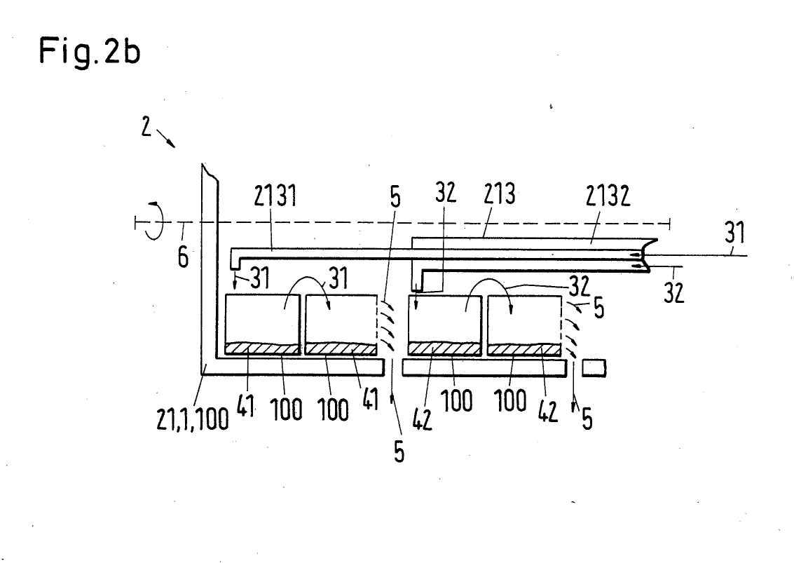

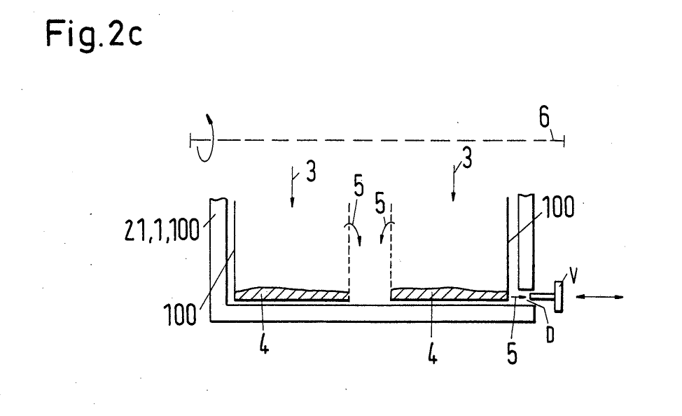

FIG. 2a a centrifuge with sub-cartridges;

FIG. 2b a second embodiment in accordance with FIG. 2a;

FIG. 2c a third embodiment in accordance with FIG. 2a with a sealable drainage path;

FIG. 3a a centrifuge cartridge with decanter weirs;

FIG. 3b a diagram for the suppression of dragging by a centrifuge cartridge in accordance with FIG. 3;

FIG. 4a an embodiment of a decanter weir;

FIG. 4b a further embodiment in accordance with FIG. 4a;

FIG. 4c a third embodiment in accordance with FIG. 4a;

FIG. 4d a sub-cartridge with overflow rib;

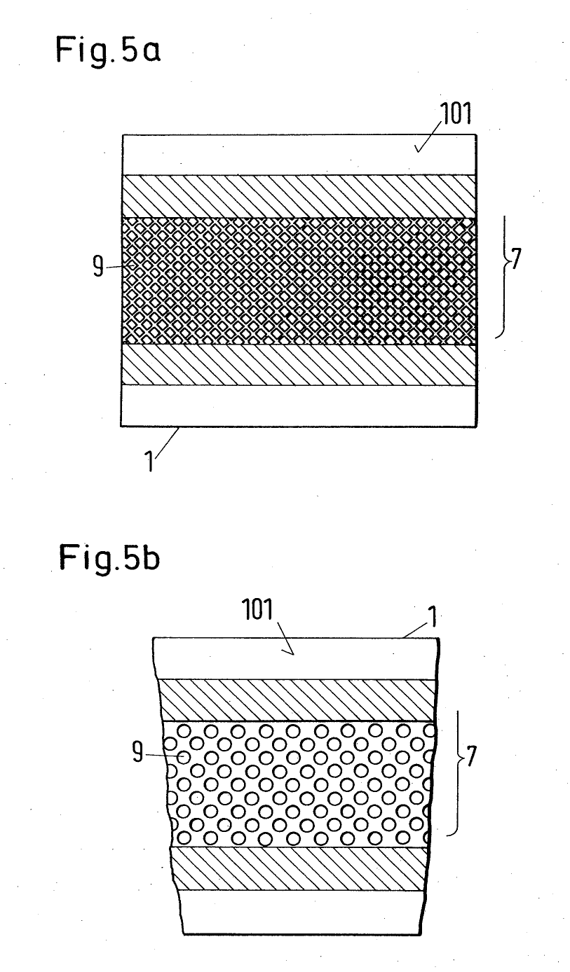

FIG. 5a an embodiment of a centrifuge cartridge with positioning chambers;

FIG. 5b an embodiment in accordance with FIG. 5a with releasably installed portioning chambers;

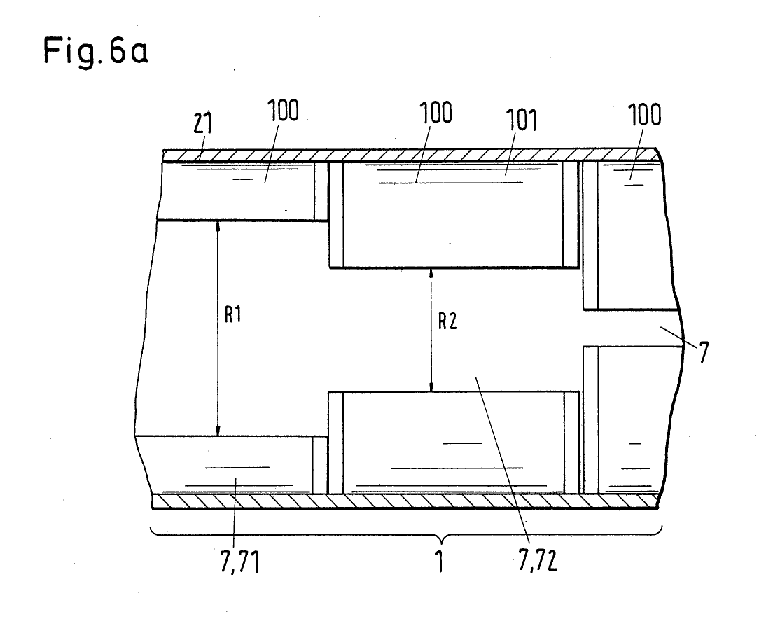

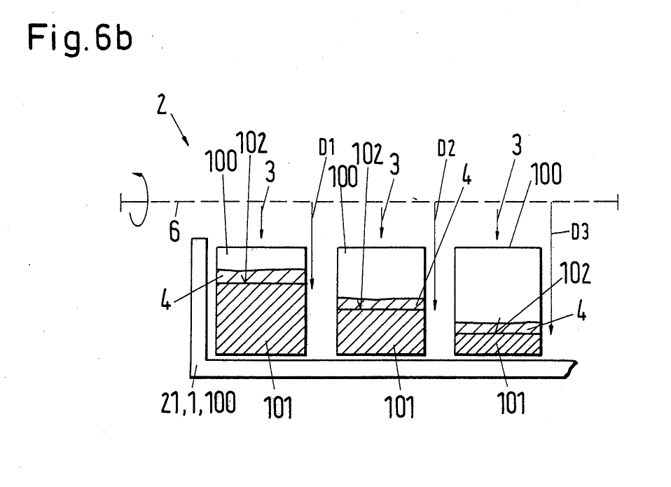

FIG. 6a sub-cartridges with different internal diameters for separation;

FIG. 6b sub-cartridges with different external diameters for separation.

FIG. 1a shows in section in a schematic representation a centrifuge with a centrifuge cartridge in accordance with the invention which is designated by the reference numeral 1 in the following. The centrifuge 2 includes in a manner known per se a centrifuge drum 21 which is driven by a rotary drive 2000 around an axis of rotation 6, is rotatably supported in a housing 200 and into which a mixture 3 to be separated can be introduced into the centrifuge drum 21 via an inlet pipe 213 A centrifuge cartridge 1 in accordance with the invention is releasably installed in the centrifuge drum 21 which has a screen 211 in the present example for the draining of a liquid phase 5.

In the operating state, a mixture 3 to be separated is introduced into the centrifuge drum 21 in a manner known per se via an inlet pipe 213 at fast rotation, with a solid cake 4 being deposited on the inner wall of the centrifuge drum 21 due to the high centrifugal forces which apply due to the fast rotation of the centrifuge drum 21, with the liquid phase 5 being drained into the housing 200 of the centrifuge 2 via the filter screen 211 and being removed from the centrifuge housing 200 via the drain 214.

To ensure a secure operation of the centrifuge 2, the centrifuge cartridge 1 is supported releasably and reliably in the centrifuge drum 21 via support means 212 which are designed as support bolts 212 in the present case. The support bolts 212, which are provided at the rear side of the centrifuge drum 21 facing the rotary drive 2000, are inserted in a corresponding cut-out at the centrifuge drum 21 such that the rotational movement of the centrifuge drum 21 can be transferred reliably and free of vibration to the centrifuge cartridge 1. The support bolts 212 provided at the top and bottom in the centrifuge drum 21 in accordance with the illustration support the centrifuge cartridge 1 in the radial direction in the centrifuge drum 21 so that overall an absolutely secure holding of the centrifuge cartridge 1 in the centrifuge drum 21 is ensured, on the one hand, and the centrifuge cartridge 1 can be assembled or disassembled in an easily reliable manner, on the other hand.

In the example of FIG. 1a, a centrifuge cartridge 1 is shown in a schematic manner which includes a stable, self-supporting drum jacket 101. It is understood that the centrifuge cartridge 1, and in particular also a sub-cartridge 100, can have a more or less non-self-supporting drum jacket 101 which can then naturally be supported at its peripheral surface via a plurality of support bolts 212 or can even be supported in the centrifuge drum 21 over the total surface of the drum jacket 101. In this case, the radial support bolts 212 can possibly be omitted.

In FIG. 1b, a specific embodiment of a centrifuge cartridge 1 is shown without drum jacket 101. The centrifuge cartridge 1 of FIG. 1b essentially includes a cartridge axis 111, which coincides, for example, with the axis of rotation 6 of the centrifuge 2 and at which one or more decanter weirs 8 are arranged such that, in the installed state, sedimentation chambers 7 are formed in the centrifuge drum 21 in which solid cake 4 can settle in the operating state of the centrifuge 2. The centrifuge cartridge 1 without a drum jacket 101 is arranged in the centrifuge drum 21 such that it rotates with the latter. For the rotationally fixed coupling of the centrifuge cartridge 1 to the centrifuge drum 21, corresponding anchoring means can be provided (not shown in FIG. 1b).

This particularly simple embodiment of a centrifuge cartridge 1 in accordance with the invention can be installed in or removed from the centrifuge drum 21 particularly simply and in particular permits a very simple emptying of the centrifuge cartridge 1 after the end of a centrifuging procedure since, as indicated by the double arrow in FIG. 1b, the centrifuge cartridge 1 can be simply pulled out of the centrifuge drum 21 along the cartridge axis, with the settled solid cake 4 simultaneously being transported out of the centrifuge drum 21 by the decanter weirs 8.

It is understood that the centrifuge cartridge 1 without a drum jacket 101 in accordance with FIG. 1b can naturally also be a sub-cartridge 100, i.e. that the centrifuge cartridge 1 without a drum jacket 101 cannot only be arranged directly in a centrifuge drum 21, but can naturally also be provided in another centrifuge cartridge 1 or even in a sub-cartridge 100.

FIG. 1c is a further embodiment in accordance with FIG. 1b. The essential difference consists of the fact that, in the embodiment in accordance with FIG. 1b, the sedimentation chambers 7 are not formed by decanter weirs 8, but by a worm 80 which is rotationally fixedly connected to the cartridge axis 111 and which, in the operating state, rotates along with the centrifuge drum 21 or, depending on the embodiment already described above, along with the centrifuge cartridge 1 or with the sub-cartridge 100 in which the worm 80 is arranged.

It is understood in another respect that all drawings are only schematic and that the representations in particular do not provide any specific indications on the actual position of installation. This means that a centrifuge drum apparently shown in a horizontal position can absolutely also be operated in a vertical structure, and vice versa, in reality.

Another embodiment in accordance with FIG. 1a is shown in FIG. 2a, with two sub-cartridges 100 being arranged in the centrifuge 2 sequentially in the axial direction with respect to the axis of rotation 6. For reasons of clarity, the representation of the inlet tube 213 of the rotary drive 2000, the representation of the support means 212 and of further components of the centrifuge 2 known per se have been omitted in FIG. 2a.

The different sub-cartridges 100 can have different functions associated with them in specific cases. In a first sub-cartridge 100, for example, a settled solid cake 4 can thus be washed or watered and not in a second one, and vice versa. It is thus quite generally possible for a plurality of sub-cartridges 100 to be provided in one and the same centrifuge drum 21 and centrifuge cartridge 1 and sub-cartridge 100 and different process steps can be carried out or the different functions in centrifuging can be satisfied in them.

The sub-cartridges 100 of FIG. 2a are made as sub-cartridges 100 open at both ends so that the mixture can be transferred, for example, from the sub-cartridge on the right in the illustration to the sub-cartridge on the left. The drag effect already explained in detail further above is in particular minimised by the structure in accordance with FIG. 2a having two sub-cartridges whose end faces are made in the form of decanter weirs 8 and the yield of solid cake per centrifuging process or the efficiency of the centrifuging is substantially increased by the chamber formation by means of two sub-cartridges 100. This positive effect will in particular be explained in more detail further below with reference to the schematic graphics of FIG. 3b. It is understood that both the sub-cartridges 100 and the centrifuge cartridges 1 can be designed in a manner known per se as a full jacket cartridge 1, 100 and/or as a filtering cartridge 1, 100 and/or as a cross-filtering cartridge 1, 100 or differently. The end surfaces of the cartridges 1, 100 can naturally also likewise be made as filtering cartridges, that is, as already mentioned, as cross-filtering cartridges 1, 100.

In a specific embodiment, as shown schematically in FIG. 2c, a drainage path D can be sealed by a closing mechanism V so that the cross-filtration is stopped in a first method step. Two process steps, namely the filtering and the settling/ compacting can thereby be carried out sequentially in a cartridge 1, 100 in an arrangement in accordance with FIG. 2c.

A section of a second embodiment in accordance with FIG. 2a is shown schematically in FIG. 2b. Two pairs of sub-cartridges 100, which are each in communication with one another for the exchange or transfer of mixture 3 from one of the sub-cartridges 1 of a pair into the adjacent sub-cartridge 100 of the same pair, are arranged in the centrifuge drum 21 which can also be a centrifuge cartridge 1 or a sub-cartridge 100. It is understood that, completely analogously to the schematic example of FIG. 3, not only pairs of two respective sub-cartridges 100 can be formed, but also cascades of more than two sub-cartridges 100 can be formed.

The particular benefit of the arrangement of FIG. 2b consists of the fact that at least two different or like mixtures 31, 32 can be dehumidified in one and the same centrifuge 2, without the two mixtures 31, 32 or the solid cakes 41, 42 settled therefrom, coming into contact with one another.

The at least two different mixtures 31, 32 are introduced into the centrifuge 2 through an inlet pipe 213, with the inlet pipe 213 being designed such that the mixtures 31, 32 do not come into contact with one another in the inlet pipe. This can e.g. be ensured in that, as shown schematically in FIG. 2b, the inlet pipe is made with at least double walls or in that a plurality of separate part pipes 2131, 2132 are provided. Preferably, just as many part tubes 2131, 2132 are provided as mixtures 31, 32 to be processed so that the different or like mixtures 31, 32 do not come into contact with one another on introduction into the centrifuge 2.

In the example shown in FIG. 2b, the mixtures 31, 32 are introduced via the part tubes 2131 and 2132 into the respective sub-cartridge 100 of a pair of sub-cartridges 100 on the left in accordance with the illustration. During centrifuging, a portion of the respective mixture 31, 32 will then settle as a solid cake 41, 42 in the respectively left hand sub-cartridge 100 of a pair of sub-cartridges 100, whereas another portion of the respective mixture 31, 32 is transported further into the respective sub-cartridge 100 of a pair of sub-cartridges 100 at the right in accordance with the illustration. The still remaining portion of solid components of the mixtures 31, 32 then settles in the respective right hand sub-cartridge 100 as a solid cake 41, 42 and the left-over liquid phase 5 is drained outwardly via filter screens at an end face of the respective right hand sub-cartridge 100.

In FIG. 3a, an embodiment of a centrifuge cartridge 1 in accordance with the invention or a sub-cartridge 100 is shown with decanter weirs 8 so that the interior space of the centrifuge cartridge 1 or of the sub-cartridge 100 is divided into three separation chambers 7 in the specific example of FIG. 3a. This embodiment is, as already mentioned further above and as will be explained in more detail by FIG. 3b, particularly suitable, on the one hand, to minimise the damaging dragging, since the uncontrolled dragging out of particles which have not yet settled is prevented by the additional decanter weirs 8 in the interior space of the centrifuge cartridge 1, 100. On the other hand, solid cakes 4 of different degrees of dehumidification and/or of different consistence and/or of different composition, for example solid cakes of different particle size, settle in the different sedimentation chambers 8 on selection of a suitable geometry or on the selection of suitable process parameters.

The diagram of FIG. 3b demonstrates in an impressive manner inter alia the suppression of dragging and the thereby substantially increased efficiency of the sedimentation of the solid cake 4 as well as the clearly improved yield of solid cake 4 by a centrifuge cartridge in accordance with FIG. 3.

The yield A of solid cake is entered on the vertical ordinate axis, while the time t of the centrifuging process is entered on the horizontal abscissa axis. The graph of FIG. 3b thus shows the total amount of settled solid cake 4 in dependence on the time t in which the centrifuge process takes place in a schematic representation.

The curve 1000 represents—in dependence on the time t—the yield A of solid cake 4 which is achieved in a centrifuge cartridge 1, 100, which is made in one piece, that is does not have separate sedimentation chambers 7, or in other words, only consists of a single sedimentation chamber 7. The curve 700 shows in an analogous manner the yield A of solid cake 4 which can be achieved with a centrifuge cartridge 1, 100 in accordance with FIG. 3a, that is with a centrifuge cartridge 1, 100 which has more than one sedimentation chamber 7.

It can be seen unequivocally from FIG. 3b that, on the one hand, the curve 700 increases much more steeply than the curve 1000 almost from the start. This means the sedimentation process takes place in a centrifuge cartridge 1, 100 with a plurality of sedimentation chambers 7 much faster from the start than in a centrifuge cartridge 1, 100 which is not divided into a plurality of sedimentation chambers 7. This means that in a centrifuge cartridge 1, 100 with a plurality of sedimentation chambers 7, the sedimentation of the solid cake takes place significantly more efficiently. Furthermore, it can be recognised unequivocally from FIG. 3b that the total yield A of solid cake 4 is also much higher with a centrifuge cartridge 1, 100 with a plurality of sedimentation chambers 7 than with a centrifuge cartridge 1, 100 which is only made up of one chamber. This can be seen quite clearly from the fact that the curve 700 runs above the curve 1000 at all times.

These extremely positive effects are not least due to the fact that the feared dragging is more or less completely suppressible by the sedimentation chambers 7 so that the sedimentation of solid cake 4 takes place faster and more efficiently and the total yield A can be noticeably increased.

In FIG. 4a to FIG. 4b, three different embodiments of decanter weirs 8 known per se are shown by way of example which can be advantageously used in a centrifuge cartridge 1, 100. The decanter weirs 8 of FIG. 4a to FIG. 4b can, as shown schematically in FIG. 3a, for example, be arranged sequentially in a centrifuge cartridge 1, 100 in accordance with the invention with respect to the axis of rotation 6 of a centrifuge 2. The decanter weir 8 is then arranged rotatably about the axis 6 in the centrifuge cartridge so that the liquid phase 5 to be drained can be decanted over the edge 83 of the decanter weir 8 in the operating state of the centrifuge 2.

Depending on the demand, specific measures can be provided for the draining of the liquid phase 5 and/or for the transport of some of the mixture 3 to be separated from one sedimentation chamber 7 into an adjoining sedimentation chamber 7 which optimise these processes in the sense of the desired result. That is, for example, to achieve an optimum efficiency in the sedimentation and/or in the sedimentation speed to set and to maintain the desired consistence of the solid cake 4 in the different sedimentation chambers 7.

To be able to achieve this, openings 81 can, as shown in FIG. 4a, be provided in the decanter weir 8 or, as shown schematically in FIGS. 4b and 4c, cut-outs 82 can be provided which, as shown in FIG. 4c, can also be realized, for example, by teeth.

If as shown in FIG. 3a, for example, a plurality of decanter weirs 8 are arranged sequentially in the axial direction in a centrifuge cartridge 1, 100, it can be advantageous to arrange the decanter weirs 8 sequentially such that the cut-outs 82 or the openings 81 of two different decanter weirs 8 are arranged with respect to one another such that the cross-sectional surfaces of the openings 81 and/or of the cut-outs 82 overlap, when viewed in the axial direction, such that a type of throughgoing “passage” is created in the axial direction by the openings and/or cut-outs 82. In another example, it can, in contrast, be more advantageous to arrange the decanter weirs 8 with respect to one another such that an opening 81 and/or a cut-out 82 of a first decanter weir 8 is/are covered by a second decanter weir 8 so that not only a “passage” is formed by overlapping cross-section surfaces of the openings 81 and/or of the cut-outs 82.

Furthermore, devices 800 such as vanes 800 or ribs 800 or also other measures 800 can be provided at the decanter weirs 8 or in addition to the decanter weirs 8 which transport the liquid in the radial direction outwardly away from the surface. Such devices 800 or measures 800 such as dip weirs 800 are known per se. A corresponding arrangement with two sub-cartridges 100 is shown schematically to illustrate their functioning in FIG. 4d. The mixture 3 is introduced into the sub-cartridge 100 at the left in accordance with the representation via devices which are not shown in more detail, with a portion of the mixture 3 of suspended solid settling as a solid cake 4 in the left hand sub-cartridge 100. Another portion of the mixture 3 then moves into the sub-cartridge 100 at the right in accordance with the representation via an end face of the left hand and/or right hand sub-cartridge 100. The mixture 3 moving into the right hand sub-cartridge 100 is first forced radially outwardly in the direction toward higher peripheral speeds of the centrifuge 2 in a manner known per se through the overflow rib 800, whereby the sedimentation process in the right hand sub-cartridge 100 is clearly improved and the effect of dragging is substantially reduced.

These recitations on decanter weirs 8 or on the overflow ribs 800 are naturally only to be understood as examples. The skilled person is fully aware of a plurality of further embodiments of decanter weirs 8 and overflow ribs 800 and of their arrangement in a rotor chamber of a centrifuge which can naturally all be used advantageously—in all suitable combinations—in a centrifuge cartridge 1, 100 in accordance with the invention.

In FIGS. 5a and 5b, two embodiments of a centrifuge cartridge 1 or of a sub-cartridge 100 are shown schematically which contain positioning chambers 9. This means e.g. that the portioning chamber 7 is further divided into portioning chambers 9 which, as shown in FIG. 5a, can have a rectangular geometry, for example, can in particular be made in the form of a honeycomb structure, or can also have a different geometry, as shown in FIG. 5b.

The portioning chambers 9 are preferably, but not necessarily designed, as removable tubes in the example of FIG. 5b, i.e. the positioning chambers 9 are releasably installed in the centrifuge cartridge 1, 100. The automatic portioning of the solid cake in predeterminable amounts in the portioning chambers 9 designed as portioning tubes is thereby possible during centrifuging and said portioning chambers can then be removed individually and comfortably and can be supplied—already automatically portioned in a predetermined amount—to a further processing step or can be made available to a customer in a ready-portioned manner.

FIG. 6a finally shows an arrangement for separation which is realised in the present case by individually disassemblable sub-cartridges 100. In FIG. 6a, three sub-cartridges 100 are shown by way of example which have different internal diameters R1, R2 and R3 so that a mixture 3 to be separated is separable in a manner known per se using the arrangement of FIG. 6a. This means that due to the different internal radii R1, R2, R3 correspondingly differently pronounced centrifugal forces also apply in the operating state in the different sub-cartridges 100 so that, for example, solid particles of different sizes settle as solid cake in the different sub-cartridges 100 and are thereby separated from one another. This means that the differently sized solid particles automatically settle in different sub-cartridges 100, which can each be individually disassembled, due to the arrangement in accordance with the invention of FIG. 6a, which naturally substantially simplifies the further processing of the solid cake or only makes it possible at all in specific cases.

Finally, sub-cartridges 100 for separation with different external diameters D1, D2, D3 are shown schematically in FIG. 6b as further variants. The different external diameters D1, D2, D3 of the sub-cartridges 100 are realised in the present example in that a dead space 101 is respectively outwardly provided in the radial direction and has a sedimentation surface 102 in the direction of the axis of rotation 6 on which the solid cake 4 settles. The mixture 3 to be separated can be separated in a manner known per se using the arrangement of FIG. 6b by the different external diameters D1, D2, D3 formed in this manner. The reason for this is that, due to the different external diameters D1, D2, D3, correspondingly differently strong centrifugal forces are effective in the operating state in the different sub-cartridges 100 so that, for example in the different sub-cartridges 100, solid cakes 4, for example, having different degrees of dehumidification and/or, when mixture 3 can move from one sub-cartridge into the next one, solid cakes 4 with, for example, different particle sizes can settle and thereby be separated from one another. This means that solid cakes 4 with different degrees of dehumidification and/or solid cakes 4 with differently sized solid particles automatically settle in different sub-cartridges 100, which can each be individually disassembled, due to the arrangement in accordance with the invention of FIG. 6b, which naturally substantially simplifies the further processing of the solid cake or only makes it possible at all in specific cases. It is clear that more than three sub-cartridges 100 having like or different external diameters can naturally also be advantageously provided.

1 and 2. (canceled)

3. A centrifuge cartridge in accordance with claim 16, wherein the centrifuge cartridge (1) is a sub-cartridge (100).

4 and 5. (canceled)

6. A centrifuge cartridge in accordance with claim 15, wherein the sedimentation chamber (7) is divided into at least two portioning chambers (9), with the sedimentation chamber (7) in particular being made in the form of a honeycomb structure.

7. A centrifuge cartridge in accordance with claim 15, wherein a decanter worm is provided to form the sedimentation chamber (7) and/or the portioning chamber (9).

8. A centrifuge cartridge in accordance with claim 16, wherein a first sedimentation chamber (71) is larger than a second sedimentation chamber (72) and/or a first portioning chamber (9) is larger than a second portioning chamber (9).

9. A centrifuge cartridge in accordance with claim 16, wherein a first radius (R1) of the first sedimentation chamber (71) is larger than a second radius (R2) of the second sedimentation chamber (72).

10 and 11. (canceled)

12. A centrifuge cartridge in accordance with claim 16, wherein an inner wall of the centrifuge cartridge (1) and/or of the sub-cartridge and/or of the centrifuge drum (21) is lined with a plastic.

13. A centrifuge cartridge in accordance with claim 16, wherein a means (12) for sealing is provided at a cartridge opening (11) of the centrifuge cartridge (1) and/or of the sub-cartridge (100); and/or the centrifuge cartridge (1) and/or the sub-cartridge (100) is/are made as a sealable container (1, 100).

14. (canceled)

15. A centrifuge cartridge according to claim 12 wherein the plastic is a hygienic plastic.

16. A centrifuge cartridge for a centrifuge (2) for the separation of a mixture (3) into a solid cake (4) and into a liquid phase (5), wherein the centrifuge cartridge (1) is rotatably supported around an axis of rotation (6) of the centrifuge (2) in the installed state, characterised in that the centrifuge cartridge (1) can be releasably installed in the centrifuge (2), in particular in a centrifuge drum (21) of the centrifuge (2), and in that sedimentation chambers (7) are formed by a decanter weir (8), in particular by a decanter weir (8) with a drainage opening (81) and/or a drainage cut-out (82) to drain the liquid phase (5).

17. A centrifuge cartridge in accordance with claim 16, wherein at least two sedimentation chambers (7) are provided in the centrifuge cartridge (1) and are arranged axially sequentially with respect to the axis of rotation (6).
